(19) United States
(12) Patent Application Publication
(10) Pub. No.: US 2009/0123901 A1
(43) Pub. Date: May 14, 2009

(54) Magnetically Mounted Motivation Device With Integrated Indicator

(76) Inventors: Ronald Eugene Hunt, Georgetown, TX (US); Verlon Eugene Whitehead, Austin, TX (US); Tod Alan Barrett, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 11/937,604

(22) Filed: Nov. 9, 2007

(51) Int. Cl. G09B 5/04

(52) U.S. Cl. 434/319

(57) ABSTRACT

A magnetically mounted motivation device with an integrated indicator is disclosed. A generally circular planar case includes a partially flexible upper surface and a lower surface that includes an acoustically transparent area. An audio storage element mounted within the generally circular planar case stores multiple spoken motivational messages. An audio output device coupled to the audio storage element is mounted within the generally circular planar case overlying the acoustically transparent area. If a switch mounted within the generally circular planar case and underlying the partially flexible upper surface is activated, the audio output device outputs one or more spoken motivational messages. A magnetic base mounted to an outer portion of the lower surface of the case surrounds the acoustically transparent area such that audio output is not impeded. A rotatable bezel mounted to the case includes multiple indicia that are indicated by a rotational position of the rotatable bezel.

### BACKGROUND OF THE INVENTION

1. Technical Field

The present invention relates in general to electronic devices and in particular to electronic motivational devices. Still more particularly, the present invention relates to an improved magnetically mounted motivation device with an integrated indicator.

2. Description of the Related Art

Dieters typically seek to achieve broad goals, such as losing a dress size or simply looking better in their clothes. Rather than continuously tracking the specific numerical value of their weight, dieters focus on round numbers (e.g., losing 10 pounds). A dieter may not wish their current weight to be displayed or widely announced to family members, friends, or passers by. Broadcasting a user's current weight can counteract the motivational effects of a weight loss system, since the user may feel embarrassed or intimidated by the numerical value of his or her weight.

Electronic devices utilize speech synthesis devices to emulate one or more human voice. In order to provide motivation to a user who is attempting to lose weight, it has been found that voice comments can be extremely beneficial. However, conventional electronic devices are not typically in proximity to a dieter at moments when the user may become tempted to stray from their diet plan (e.g., in a kitchen).

Consequently, it would be desirable to provide an improved magnetically mounted motivation device with an integrated indicator.

### SUMMARY OF THE INVENTION

Disclosed is a magnetically mounted motivation device with an integrated indicator. A generally circular planar case includes a partially flexible upper surface and a lower surface that includes an acoustically transparent area. An audio storage element mounted within the generally circular planar case stores multiple spoken motivational messages. An audio output device coupled to the audio storage element is mounted within the generally circular planar case overlying the acoustically transparent area. If a switch mounted within the generally circular planar case and underlying the partially flexible upper surface is activated, the audio output device outputs one or more of the spoken motivational messages. A magnetic base mounted to an outer portion of the lower surface of the generally circular planar case surrounds the acoustically transparent area such that audio output is not impeded. A rotatable bezel mounted to the generally circular planar case includes multiple indicia that are indicated by a rotational position of the rotatable bezel.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1A depicts a high level block diagram of a magnetically mounted motivational device with an integrated indicator, as utilized in an embodiment of the present invention;

FIG. 1B depicts a high level block diagram of an “exploded” view of the components within the magnetically mounted motivational device of FIG. 1A, as utilized in an embodiment of the present invention; and

FIG. 2 is a high level logical flowchart of an exemplary method of providing motivation, in accordance with one embodiment of the invention.

### DETAILED DESCRIPTION OF AN ILLUSTRATIVE EMBODIMENT

The present invention provides a magnetically mounted motivation device with an integrated indicator.

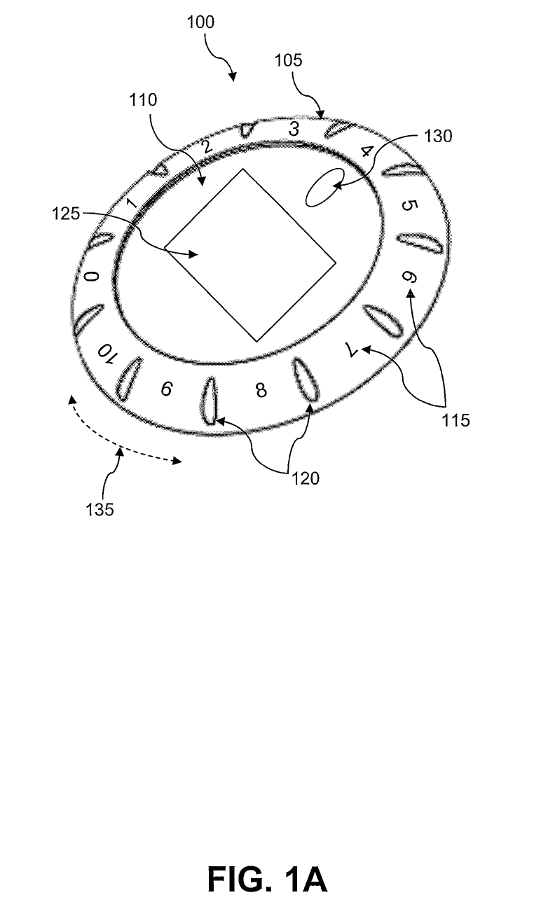

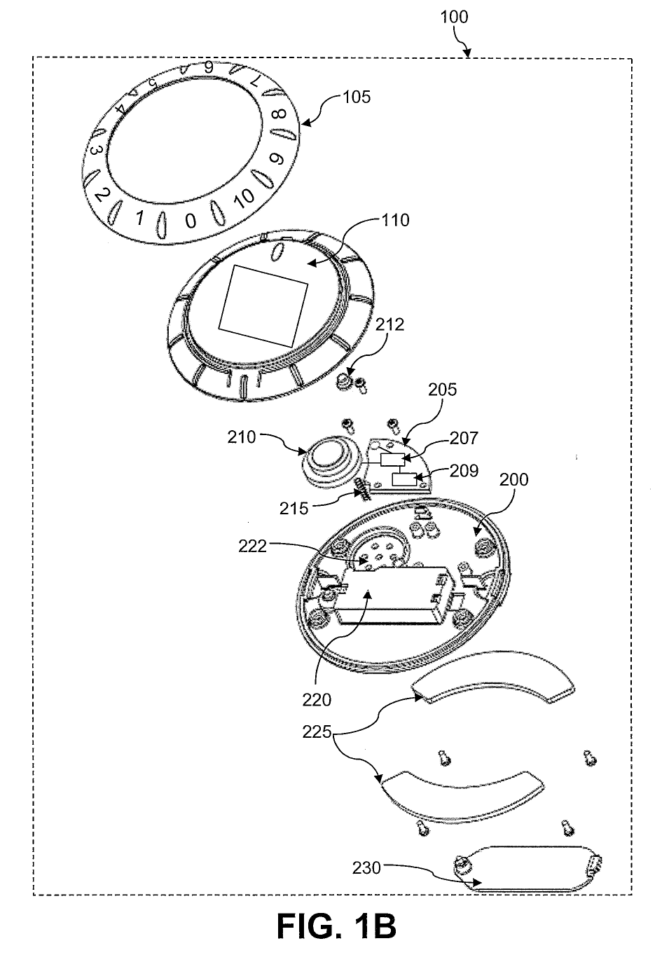

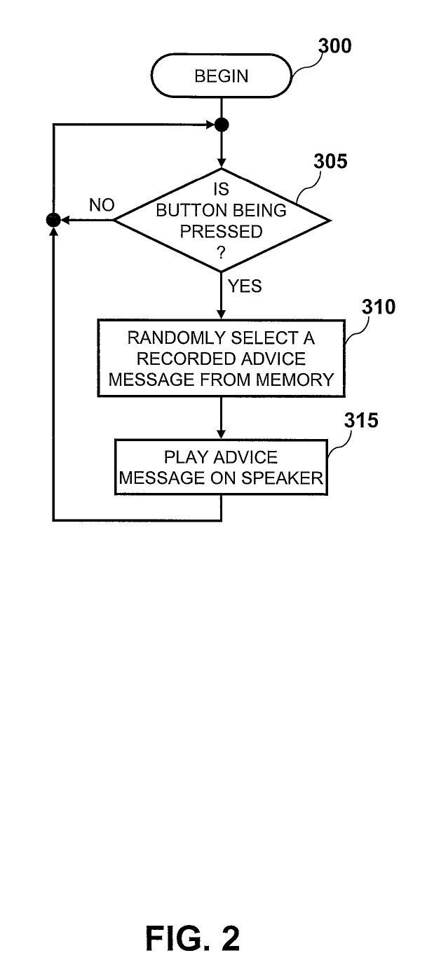

With reference now to FIG. 1A, there is depicted a high level block diagram of a magnetically mounted motivational device with an integrated indicator, as utilized in an embodiment of the present invention. As shown, magnetically mounted motivation device 100 includes an indicator 105 and a partially flexible upper surface, such as front shell 110. Front shell 110 may be a partially flexible rubber dome, partially flexible plastic shell, or the like. As utilized herein, an indicator refers to a rotatable bezel, ring, rim, and/or covering that fits on top of front shell 110 and may move rotationally with respect to front shell 110, as shown by motion line 135. Motion line 135 is provided for illustrative purposes only. A user of magnetically mounted motivation device 100 may selectively press the partially flexible front shell 110 to actuate a push button that performs the functions illustrated in FIG. 2 that are described below.

According to the illustrative embodiment, indicator 105 includes multiple indicia, such as numbers 115, and multiple textured grips 120. Numbers 115 may include the integers 0 through 10, each of which may correspond to a number of pounds lost by a user of magnetically mounted motivation device 100 and/or a goal of the user (e.g., a target weight loss). Textured grips 120 are spaced evenly between each of numbers 115. Textured grips 120 may include raised, dimpled, and/or hollow surfaces. Front shell 110 includes a graphical logo 125 and a reference mark 130, which may point to one of numbers 115 on indicator 105 (i.e., a “current setting” of indicator 105). For example, if a user positions indicator 105 such that the number “4” is in proximity to reference mark 130, then magnetically mounted motivation device 100 visually indicates that the user has lost and/or wishes to lose 4 pounds. Graphical logo 125 may include pictures and/or text.

In one embodiment, textured grips 120 may be positioned with respect to numbers 115 such that textured grips 120 correspond to fractional values between numbers (i.e., halves). For example, if a user positions indicator 105 such that the grip between number 4 and number 5 is in proximity to reference mark 130, then indicator 105 corresponds to a current setting of 4.5.

In an alternate embodiment, numbers 115 may correspond to a number of snacks eaten by a user in a day. Similarly, numbers 115 may correspond to a number of drinks (e.g., protein shakes) consumed by a user in a day. In another embodiment, reference mark 130 may include a light source, such as a light emitting diode (LED).

With reference now to FIG. 1B, there is depicted a high level block diagram of an “exploded” view of the components within magnetically mounted motivational device 100 (FIG. 1A), as utilized in an embodiment of the present invention. As shown, magnetically mounted motivation device 100 includes indicator 105 and front shell 110 (FIG. 1A). Magnetically mounted motivation device 100 also includes a generally circular planar case, such as bottom shell 200. Bottom shell 200 includes a battery case 220, which in turn includes a battery case cover 230. A magnetic base that may include multiple magnets 225 are mounted to a lower surface of bottom shell 200 (i.e., a rear surface of the generally circular planar case that is opposite front shell 110). Magnets 225 enable magnetically mounted motivational device 100 to be held in place on a metallic surface, such as a refrigerator, microwave oven, stove, or metallic message board. In one embodiment, magnets 225 may be generally crescent shaped.

According to the illustrative embodiment, a printed circuit board (PCB) 105 is connected to bottom shell 200. PCB 205 includes a control and timing circuit 207 and an audio storage device, such as flash memory 209. An audio output device, such as speaker 210, is coupled to control and timing circuit 207. In one embodiment, speaker 210 may be a 0.25 Watt speaker or a piezoelectric audio output device. Speaker 210 is mounted on speaker mount 222, which includes an acoustically transparent surface (e.g., one or more openings in the back surface of bottom shell 200). Speaker mount 222 is positioned between magnets 225, which offset speaker mount 222 from the metallic surface (e.g., a refrigerator door) by a distance at least equal to the thickness of magnets 225, thereby enabling sound to escape (i.e., unimpeded) out of the back surface of bottom shell 200. In one embodiment, magnets 225 may at least partially surround speaker mount 222, such that magnets 225 do not impede audio output from speaker 210.

In one embodiment, a push button 212 is also coupled to control and timing circuit 207 on PCB 205. Push button 212 may be a mechanically-actuated switch, such as a partially flexible rubber dome switch, a movable plastic switch, or the like. When a user presses front shell 110 against a mechanical spring 215 across a distance that enables front shell 110 to actuate push button 212, control and timing circuit 207 plays recorded audio segments from flash memory 209 using a piezoelectric audio output device and/or speaker 210, as shown in FIG. 2, which is described below. Flash memory 209 may include multiple recorded audio segments. In one embodiment, the recorded audio segments include different sentences and/or phrases of vocal motivational advice.

Turning now to FIG. 2, there is illustrated an exemplary method of providing motivation, in accordance with one embodiment of the invention. The process begins at block 300 and proceeds to block 305, where control and timing circuit 207 (FIG. 1B) determines whether or not front surface 110 (FIGS. 1A-1B) has been pressed into push button 212 (FIG. 1B). If push button 212 has not been pressed, the process returns to block 305, and control and timing circuit 207 continues to monitor push button 212.

Otherwise, if push button 212 has been pressed, control and timing circuit 207 randomly selects an audio segment (e.g., a recorded advice message) from flash memory 209 (FIG. 1B), as depicted in block 310. Control and timing circuit 207 subsequently plays the selected audio segment using speaker 210 (FIG. 1B), as shown in block 315, and the process returns to block 305. In an alternate embodiment, control and timing circuit 207 may select and play audio segments in a pre-defined (i.e., non-random) order from flash memory 209. In another embodiment, control and timing circuit 207 may select and play audio segments based on the current setting of indicator 105 (FIGS. 1A-1B) in relation to reference mark 130 (FIG. 1A).

In one embodiment, advice messages include, but are not limited to, vocal commentary that is relevant to dieters, such as “Stop eating at least three hours before bedtime. This allows your body to digest your food properly”, “Are you feeling stressed? Go exercise. Exercise is a great stress reliever”, and the like.

The present invention thus provides a magnetically mounted motivation device with an integrated indicator. A generally circular planar case, such as bottom shell 200 (FIG. 1B), includes a partially flexible upper surface, such as front shell 110 (FIGS. 1A-1B), and a lower surface that includes an acoustically transparent area, such as speaker mount 222 (FIG. 1B). An audio storage element, such as flash memory 209 (FIG. 1B), mounted within the generally circular planar case stores multiple spoken motivational messages. An audio output device, such as speaker 210 (FIG. 1B), coupled to the audio storage element is mounted within the generally circular planar case overlying the acoustically transparent area. If a switch, such as push button 212 (FIG. 1B), mounted within the generally circular planar case and underlying the partially flexible upper surface is activated, the audio output device outputs one or more of the spoken motivational messages. A magnetic base, such as magnets 225 (FIG. 1B), mounted to an outer portion of the lower surface of the generally circular planar case surrounds the acoustically transparent area such that audio output is not impeded. A rotatable bezel, such as indicator 105 (FIGS. 1A-1B), mounted to the generally circular planar case includes multiple indicia that are indicated by a rotational position of the rotatable bezel (i.e., with respect to reference mark 130).

It is understood that the use herein of specific names are for example only and not meant to imply any limitations on the invention. The invention may thus be implemented with different nomenclature/terminology and associated functionality utilized to describe the above devices/utility, etc., without limitation.

While the invention has been particularly shown and described with reference to a preferred embodiment, it will be understood by those skilled in the art that various changes in form and detail may be made therein without departing from the spirit and scope of the invention.

What is claimed is:

1. A motivational device comprising:
a generally circular planar case having a partially flexible upper surface and a lower surface having an acoustically transparent area therein;
an audio storage element mounted within said generally circular planar case for storing a plurality of spoken motivational messages;
an audio output device coupled to said audio storage element for audibly outputting one or more of said plurality of spoken motivational messages, said audio output device mounted within said generally circular planar case overlying said acoustically transparent area in said lower surface of said generally circular planar case;
a switch mounted within said generally circular planar case underlying said partially flexible upper surface for causing one or more spoken motivational messages to be coupled from said audio storage element to said audio output device in response to an activation thereof;
a magnetic base mounted to an outer portion of said lower surface of said generally circular planar case surrounding said acoustically transparent area such that audio output of said audio output device is not impeded; and
a rotatable bezel mounted to said generally circular planar case having a plurality of indicia thereon for indicating a particular indicia in response to a rotational position thereof.

2. The motivational device of claim 1, wherein said partially flexible upper surface comprises a rubber dome.

3. The motivational device of claim 1, wherein the audio storage device comprises flash memory.

4. The motivational device of claim 1, wherein the audio output device comprises a speaker.

5. The motivational device of claim 1, wherein the magnetic base comprises a pair of generally crescent shaped magnetic plates.

6. The motivational device of claim 1, wherein said rotatable bezel having a plurality of indicia thereon comprises a rotatable bezel having numerals one through ten thereon.

7. The motivational device of claim 6, further including an indicator on an upper surface of said generally circular planar case for indicating selection of a particular numeral on said rotatable bezel.
